(19) United States
(12) Patent Application Publication
(10) Pub. No.: US 2005/0238794 A1
(43) Pub. Date: Oct. 27, 2005

(54) Method and apparatus for coloring three-dimensional object

(75) Inventors: Dong Yol Yang, Daejeon (KR); Min Sup Song, Daejeon (KR); Sang Ho Lee, Daejeon (KR); Hyo Chan Kim, Jeonju (KR)

Correspondence Address: BRINKS HOFER GILSON & LIONE, P.O. BOX 10395, CHICAGO, IL, 60610, US

(73) Assignee: Korea Advanced Institute of Science and Technology

(21) Appl. No.: 11/114,606

(22) Filed: Apr. 26, 2005

(30) Foreign Application Priority Data
Apr. 27, 2004 (KR) 2004-29128

(51) Int. Cl. B05D 7/00; B05D 1/00; B05C 15/00

(52) U.S. Cl. 427/8; 427/421.1; 118/300; 118/665

(57) ABSTRACT

The present invention relates a method of coloring a three-dimensional (3D) object while moving the 3D object or a pigment spray nozzle based on the configuration and color data of the 3D object. The method includes the steps of (a) setting the movement path of the 3D object or the pigment spray nozzle based on the configuration data, (b) identifying a narrow color region whose curvature is large and whose range to be colored is narrow, and a wide color region whose curvature is small and whose range to be colored is wide, and (c) coloring the narrow color region and the wide color region identified at step (b) selectively using different pigment spray nozzles whose sizes are different from each other while moving the 3D object or the pigment spray nozzles along the movement path set at step (a).

This application claims under 35 U.S.C. § 119 the benefit of the filing date of Apr. 27, 2004 of Korean Application No. 2004-29128, the entire contents of which are incorporated herein by reference.

### BACKGROUND

1. Technical Field

The present invention relates to a method and apparatus for coloring a three-dimensional object and, more particularly, a method and apparatus for coloring a narrow region of a three-dimensional object.

2. Description of the Related Art

Generally, methods of coloring three-dimensional (3D) objects are performed mainly by a manual process. To reduce inconvenience of a manual process, an inkjet method is used for coloring a 3D object.

An apparatus for coloring a 3D object having flat surfaces is disclosed in Korean Utility Model Registration No. 284766. The apparatus three-dimensionally colors a 3D object by moving a head unit that sprays ink. The apparatus uses a difference in height between the 3D object and the head unit. The head unit moves in a two-dimensional plane, whereas the 3D object is fixed on a printer. Accordingly, the apparatus requires that a user rotate the 3D object sequentially to color another side of the 3D object after a coloring operation for one side of the 3D object is completed. Furthermore, since the apparatus includes a head unit that moves in a two-dimensional plane, the apparatus is unsuitable for a 3D object whose curvature is large.

An apparatus for coloring a 3D object whose curvature is large is disclosed in Korean Patent Publication No. 2003-69916. The apparatus allows an inkjet device to perform a coloring operation while the inkjet device maintains uniform distance and angle with respect to the 3D object. Accordingly, the apparatus enables more precise coloring than the apparatus disclosed in Korean Utility Model Registration No. 284766. The inkjet device maintains the uniform distance with respect to the surface of the 3D object, during the movement. The apparatus is problematic in that the inkjet device and the 3D object interfere with each other where the curvature of the 3D object is considerably large. Furthermore, it is difficult to locate the inkjet nozzle of the apparatus to be perpendicular to the surface of the 3D object due to such interference.

A method of printing on a curved surface is disclosed in Korean Patent No. 330945. This method is limited to printing pictures or characters on a spherical object using a control system. Accordingly, it may not perform precise coloring on an object having a randomly curved 3D surface.

As described above, the prior art does not properly color 3D objects having curvatures, and it is difficult to precisely color the randomly curved 3D surface. Accordingly, there is a need for a method and apparatus of coloring a 3D object that properly uses the configuration and color data of the 3D object. Further, there is a need for a method of coloring a 3D object that easily colors the curved parts and narrow regions of the 3D object.

### BRIEF SUMMARY

The present invention provides a method for coloring a 3D object while moving the 3D object or a pigment spray nozzle based on configuration and color data of the 3D object. The method includes the steps of (a) setting the movement path of the 3D object or the pigment spray nozzle based on the configuration data, (b) identifying a narrow color region whose curvature is large and whose range to be colored is narrow, and a wide color region whose curvature is small and whose range to be colored is wide, and (c) coloring the narrow color region and the wide color region identified at step (b) selectively using different pigment spray nozzles whose sizes are different from each other while moving the 3D object or the pigment spray nozzles along the movement path set at step (a).

The present invention further provides an apparatus for coloring a 3D object that colors the surface of the 3D object based on the configuration and color data of the 3D object. The apparatus includes a pigment spray nozzle coloring the wide region of the 3D object and an auxiliary spray nozzle having a spray region narrower than that of the pigment spray nozzle and coloring the narrow region of the 3D object. The apparatus further includes feeding devices freely moving the pigment spray nozzle and the auxiliary spray nozzle in three directions perpendicular to each other, and a control device operating the feeding devices, the pigment and the auxiliary spray nozzles based on the configuration and color data of the 3D object.

With the development of design technology using a computer, most of product designs are performed using computer programs, such as Computer Aided Design (CAD). Accordingly, most of 3D objects have relatively precise configuration and color data for the configurations thereof. The present invention provides a method of coloring a 3D object using such data.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a flowchart schematically showing a process of coloring a 3D object according to an embodiment of the present invention;

FIGS. 2a and 2b are views showing concepts of the use of a pigment spray nozzle based on the 3D object coloring method of the present invention;

FIG. 3 is a flowchart schematically showing a process of coloring a 3D object according to another embodiment of the present invention;

FIG. 4 is a perspective view showing an apparatus for coloring the 3D object according to the present invention;

FIG. 5 is a perspective view showing an indexing table shown in FIG. 4; and

FIG. 6 is a view showing a coloring process using the coloring apparatus of FIG. 4.

### DETAILED DESCRIPTION OF PREFERRED EMBODIMENTS

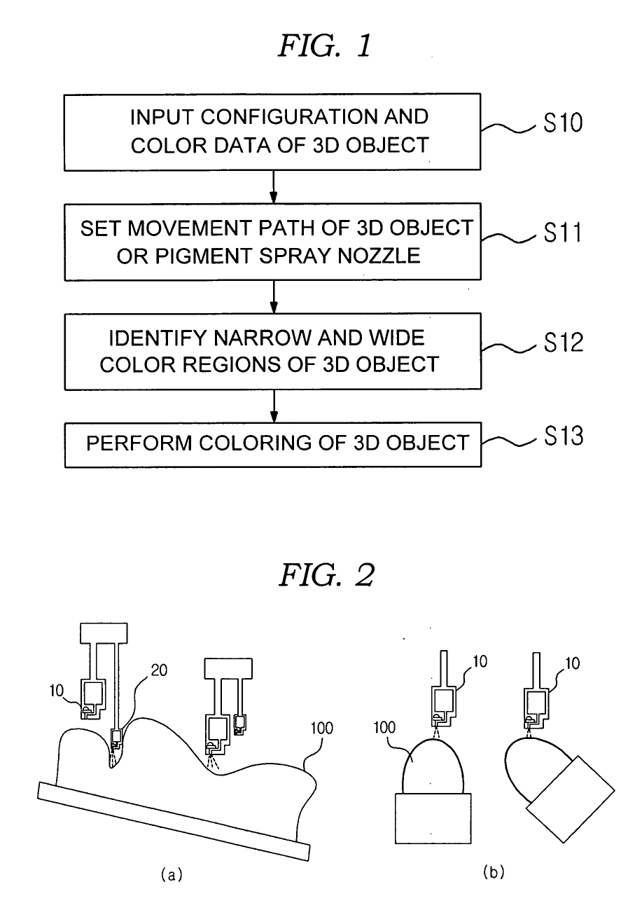

Referring to FIGS. 1 and 2, a first embodiment of a coloring method is described. FIG. 1 is a flowchart showing a first embodiment of a coloring method. FIGS. 2a and 2b are views showing use of a pigment spray nozzle.

First step S10

A 3D object to be colored is selected, and configuration and color data of the selected 3D object are input to a calculating device. In this case, the calculating device imports an auxiliary device that is provided in a general computer or a coloring apparatus. The input data is information that is used to represent a surface of the 3D object based on the configuration data and the color data.

Second step S11

The movement path of the pigment spray nozzle or the 3D object is set based on the configuration and color data. In this case, the movement path imports a path along which the pigment spray nozzle moves to completely color the surface of the 3D object. Practically, the movement path imports the path along on a feeding device. The pigment spray nozzle or the 3D object is placed on the feeding device. The movement path is set to maintain the distance between the pigment spray nozzle and the 3D object at the shortest distance. This is because this is that the precision of coloring increases as the distance between the pigment spray nozzle and the 3D object is shorter. There may be various methods of calculating the shortest distance between the pigment spray nozzle and the 3D object. Some of the methods are described below.

First, the movement path and spray angle of the pigment spray nozzle are calculated with respect to the surface of the 3D object. Second, the shortest effective coloring distance of the pigment spray nozzle is calculated, and the calculated value is changed to a vector value in which the spray angle is considered. Lastly, a new movement path is set by uniformly adding the vector value to the value of the movement path of the pigment spray nozzle. As a result, the new movement path along which the pigment spray nozzle moves is calculated. The new movement path remains spaced apart from the movement path by a certain distance (effective coloring distance) and is set with respect to the surface of the 3D object.

Another method is to mount a distance sensor on the pigment spray nozzle and assign a certain error value to the distance sensor. If the value of a certain error value (e.g., the shortest effective coloring distance of the pigment spray nozzle) is input to and set on the distance sensor, the pigment spray nozzle remains spaced apart from the 3D object by the set error value during the movement. Accordingly, during the movement, the pigment spray nozzle can keep a uniform distance from the 3D object by properly controlling the error value.

Third step S12

The 3D object to be colored is divided into a narrow color region and a wide color region based on the configuration and color data. The narrow color region is a region where a macro-sized pigment spray nozzle mounted on a coloring apparatus may not properly or precisely perform coloring (e.g., because the curvature is very large or color region is very narrow), and the wide color region is a region where the pigment spray nozzle can easily perform coloring because the curvature thereof is small. It is determined whether a color region is a narrow color region or a wide color region through the calculation of the curvature and an area to be colored with respect to the start point of the coloring based on the information input at first step S10. Additionally, an angle formed by the pigment spray nozzle and the surface of the 3D object to be colored is calculated, and it is determined whether the color region is a narrow color region or a wide color region according to the calculated spray angle of the pigment spray nozzle.

Fourth step S13

The 3D object is colored using the pigment spray nozzle. A main process of coloring the 3D object is performed in such a way that the pigment spray nozzle moves along the movement path set at the second step S11. However, the precision of the coloring may be deteriorated if the narrow color region is colored using the macro-sized pigment spray nozzle, so that it is required to color the narrow color region using a micro-sized auxiliary spray nozzle. The pigment spray nozzle 10 and the auxiliary spray nozzle 20, which are integrated with each other as shown in FIG. 2a, move along the movement path set at the second step S11, and the 3D object 100 is colored by selectively using the pigment spray nozzle 10 and the auxiliary spray nozzle 20 based on the characteristics of a region to be colored. A narrow region whose curvature is large may be precisely colored using the auxiliary spray nozzle 20 because the nozzle 20 is more precise than the pigment spray nozzle 10.

Meanwhile, if the spray nozzles 10 and 20 spray pigment while remaining inclined with respect to the surface of the 3D object 100, the precision of the coloring may be deteriorated and a difference in color concentration occurs. Accordingly, it is preferable to maintain the spray angles of the spray nozzles 10 and 20 to be perpendicular to the surface of the 3D object 100 as shown in FIG. 2b.

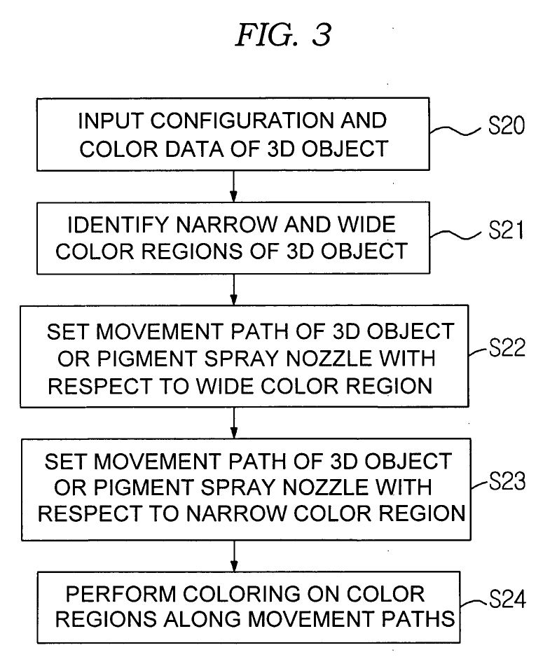

Referring to FIG. 3, a second embodiment of a coloring method is described.

First step S20

A 3D object to be colored is selected, and the configuration and color data of the selected 3D object is input to a calculating device. This step is the same as first step S10 of the first embodiment.

Second step S21

The 3D object is divided into a narrow color region and a wide color region based on the configuration and color data. The narrow color region and the wide color region are the same as the first embodiment.

Third step S22

The movement path of the pigment spray nozzle is set so as to color only the wide color region determined at the second step S21.

Fourth step S23

The movement path of the auxiliary spray nozzle is set so as to color only the narrow color region determined at the second step S21.

Fifth step S24

The 3D object is colored while the pigment spray nozzle and the auxiliary spray nozzle move along the movement paths set at the third and fourth steps S22 and S23, respectively. The coloring is performed according to a sequence in which the macro-sized pigment spray nozzle colors the wide color region, moving along the movement path set at the third step S22, and thereafter, the micro-sized auxiliary spray nozzle colors the narrow color region, moving along the movement path set at the fourth step S23. The second embodiment is different from the first embodiment in that the movement paths are set according to spray nozzles, respectively, and the steps of coloring the wide color region and the narrow color region are divided.

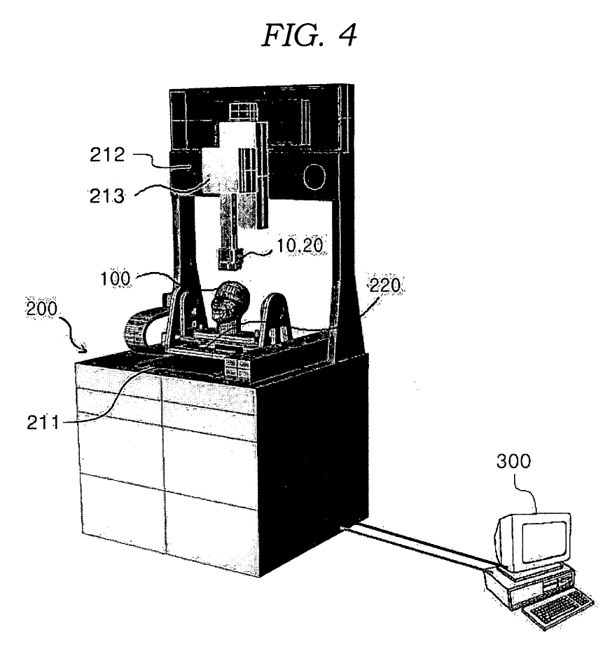

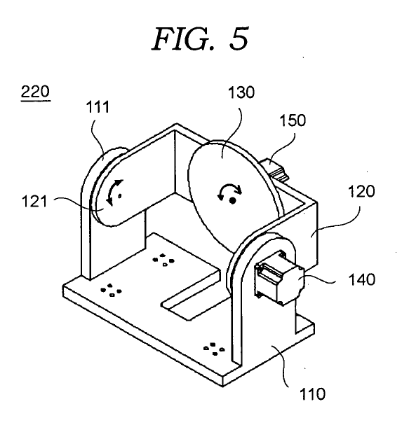

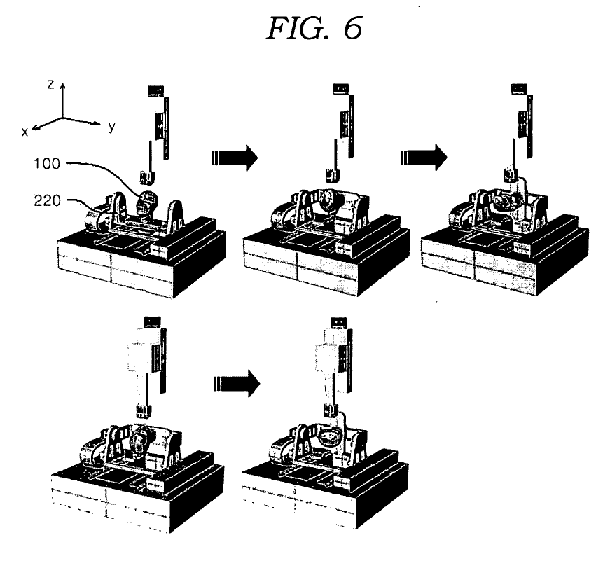

A coloring apparatus for coloring a 3D object is described referring to FIGS. 4-6. FIG. 4 is a perspective view showing an apparatus for coloring a 3D object. FIG. 5 is a view showing an indexing table shown in FIG. 4. FIG. 6 is a view showing a coloring process using the coloring apparatus of FIG. 4.

As shown in FIG. 4, the coloring apparatus 200 includes spray nozzles 10 and 20, a first feeding device 211, a second feeding device 212, a third feeding device 213, an indexing table 220, and a control device 300.

The 3D object 100 is fixedly mounted on the indexing table 220, which is placed on the first feeding device 211. The first feeding device 211 is placed on the portion of the coloring apparatus 200. The first feeding device 211 functions to move the indexing table 220 in a horizontal direction (x-axis direction). The second feeding device 212 is mounted on a portion of the coloring apparatus 200 while remaining spaced apart from the first feeding device 211 by a certain height, and functions to move the third feeding device 213 in a horizontal direction (y-axis direction) in which the third feeding device 213 moves to be perpendicular to the moving direction of the first feeding device 211. The third feeding device 213 is mounted on the second feeding device 212. The spray nozzles 10 and 20, which have sizes different from each other, are placed on the third feeding device 213. The third feeding device 213 functions to move the spray nozzles 10 and 20 in a vertical direction (z-axis direction) with respect to the moving direction of the second feeding device 212.

The spray nozzles 10 and 20 mounted on the third feeding device 213 move in a direction perpendicular to the moving direction of the first feeding device 211 in a horizontal plane and move in a vertical direction according to the operations of the second feeding device 212 and the third feeding device 213, respectively. Accordingly, the spray nozzles 10 and 20 secure a region, which allows the spray nozzles 10 and 20 to move in an x-axis direction, by the first feeding device 211 that moves the indexing table 220, and the spray nozzles 10 and 20 secure regions, which allow the spray nozzles 10 and 20 to move in y-axis and z-axis directions, by the second and third feeding devices 212 and 213, respectively. Accordingly, the spray nozzles 10 and 20 have 3D color regions with respect to the 3D object fixed on the indexing table 220. The feeding devices 211, 212 and 213, and the indexing table 220 move in determined paths, respectively, by the control device 300 that is connected to the feeding devices 211, 212 and 213 and the indexing table 220 in a wired or wireless manner.

The indexing table 220 is movably mounted on the coloring apparatus 200 in a horizontal direction and functions to secure the 3D object thereon. Additionally, the indexing table 220 functions to rotate the 3D object 100 around two perpendicular axes so that the spray nozzles 10 and 20 easily color all the surfaces of the 3D object 100. The control device 300 functions to set and control the movement paths of the spray nozzles 10 and 20, the feeding devices 211, 212 and 213, and the indexing table 220.

As shown in FIG. 5, the indexing table 220 includes a support frame 110, a seat member 120 and a vacuum chuck 130. The support frame 110 is placed on the first feeding device 211, and the seat member 120 is placed on the support frame 110. Vertical support arms 111 are formed on both sides of the support frame 110. The seat member 120 is combined with the support arms 111 to be rotated around a combination axis. Both ends of the seat member 120 are bent at right angles to be easily combined with the support arms 111, respectively. The vacuum chuck 130 is combined with the center portion of the seat member 120.

A first motor 140 and a second motor 150 are combined with one of the support arms 111 and the seat member 120 to rotate the axis-combined seat member 120 and the vacuum chuck 130, respectively. The 3D object 100 is fixed on the seat member 120 using the vacuum chuck 130. The 3D object 100 can be rotated at an angle of 360° around the y-axis by the second motor 150. It can also be rotated around an x-axis by the first motor 140. Accordingly, if the second motor 150 rotates the 3D object at a certain angle, a side of the 3D object is placed in the spray region of the spray nozzles 10 and 20, so that it is possible to perform coloring on the side. Additionally, if the first motor 140 rotates the seat member 120 in a clockwise direction, the upper or lower side of the 3D object is placed in the spray region of the spray nozzles 10 and 20, so that it is possible to perform the coloring on the upper or lower side.

The operation sequence of the coloring apparatus 200 is described below. As shown in FIG. 6, the upper side of the 3D object is first colored, and the back side of the 3D object is colored by rotating the indexing table at an angle of 90° around the y-axis. Thereafter, both sides of the 3D object are colored after rotating the indexing table 220 at an angle of 90° around the x-axis. All the sides of the 3D object are colored while selectively using different spray nozzles according to the curvatures of color regions.

As described, in the first and second embodiments, a micro-sized spray nozzle is separately provided. Alternatively, or additionally, a spray nozzle coloring a wide region at one time may be mounted. If such spray nozzle capable of coloring the wide region at one time is mounted, there is an advantage that the coloring operation using a single color can be rapidly performed.

The present invention can increase the precision of coloring in such a way that a 3D object is divided into regions according to curvatures and areas, and the divided regions are colored selectively using different pigment spray nozzles that are suitable for the characteristics of the regions, respectively. Furthermore, the present invention allows the 3D object fixed on an indexing table to be rotated around two perpendicular axes, so that the surface of the 3D object can be colored at one time. Accordingly, the present invention can perform the coloring operation of the 3D object more rapidly and easily.

Although the method and apparatus for coloring the 3D object of the present invention have been described with reference to the attached drawings, the preferred embodiments of the present invention have been described only for illustrative purposes, but the present invention is not limited to the embodiments. Those skilled in the art will appreciate that various modifications, additions and substitutions are possible, without departing from the scope and spirit of the invention as disclosed in the accompanying claims.

It is therefore intended that the foregoing detailed description be regarded as illustrative rather than limiting, and that it be understood that it is the following claims, including all equivalents, that are intended to define the spirit and scope of this invention.

1. A method for coloring a three-dimensional (3D) object configured to move based on configuration data and color data of the 3D object, comprising the steps of:
a) setting a movement path of the 3D object based on the configuration data;
b) identifying a narrow color region and a wide color region, wherein the narrow color region includes large curvature and a narrow range to be colored, and a wide color region includes small curvature and a wide range to be colored; and
c) coloring the narrow color region and the wide color region identified at the step (b) selectively using a pigment spray nozzle.

2. The method of claim 1, wherein the step (c) further comprises using at least two pigment spray nozzles, the nozzles having different sizes.

3. The method of claim 1, wherein the step (c) further comprises moving the 3D object along the movement path set at the step (a).

4. The method of claim 1, wherein the step (c) further comprises coloring the narrow color region and the wide color region sequentially and serially.

5. The method of claim 1, wherein, the step (a) further comprises setting the movement path of the 3D object to make the pigment spray nozzle perpendicular to a surface of the 3D object.

6. The method as set forth in claim 1, wherein the step (a) further comprises setting a distance between the pigment spray nozzle and the 3D object to be a shortest distance.

7. A method for coloring a three-dimensional (3D) object wherein a pigment spray nozzle moves based on configuration data and color data of the 3D object, comprising the steps of:
a) setting a movement path of the pigment spray nozzle based on the configuration data;
b) identifying a narrow color region and a wide color region, wherein the narrow color region includes large curvature and a narrow range to be colored, and a wide color region includes small curvature and a wide range to be colored; and
c) coloring the narrow color region and the wide color region identified at the step (b) selectively using the pigment spray nozzle.

8. The method of claim 7, wherein the step (c) further comprises using at least two pigment spray nozzles, the nozzles having different sizes.

9. The method of claim 7, wherein the step (c) further comprises moving the pigment spray nozzle along the movement path set at the step (a) during the coloring.

10. The method of claim 7, wherein the step (c) further comprises coloring the narrow color region and the wide color region sequentially and serially.

11. The method of claim 7, wherein, the step (a) further comprises setting the movement path of the pigment spray nozzle to be perpendicular to a surface of the 3D object.

12. The method as set forth in claim 7, wherein the step (a) further comprises setting a distance between the pigment spray nozzle and the 3D object to be a shortest distance.

13. An apparatus for coloring a 3D object based on configuration data and color data of the 3D object, comprising:
a pigment spray nozzle coloring a wide region of the 3D object;
a feeding device for moving the pigment spray nozzle in three directions perpendicular to one another; and
a control device operating the feeding device and the pigment spray nozzle based on the configuration data and color data of the 3D object.

14. The apparatus of claim 13, further comprising an auxiliary spray nozzle having a spray region narrower than that of the pigment spray nozzle and coloring a narrow region of the 3D object.

15. The apparatus of claim 13, wherein the feeding device moves the auxiliary spray nozzle in three directions perpendicular to one another.

16. The apparatus of claim 13, wherein the control device operates the auxiliary spray nozzle based on the configuration data and color data of the 3D object.

17. The apparatus of claim 13, further comprising an indexing table configured to secure and rotate the 3D object.

18. The apparatus of claim 17, wherein the indexing table comprises:
a support frame having vertical support arms;
a seat member combined with the support arms to be rotated around one of three axes of the feeding devices; and,
a vacuum chuck mounted on the seat member and configured to secure the 3D object.

19. The apparatus of claim 18, wherein the indexing table rotates in a direction perpendicular to a rotation direction of the seat member, thereby rotating the 3D object in two-axis directions perpendicular to each other and coloring all surfaces of the 3D object by a single process.
